(19) United States
(12) Patent Application Publication
(10) Pub. No.: US 2019/0019497 A1
(43) Pub. Date: Jan. 17, 2019

(54) EXPRESSIVE CONTROL OF TEXT-TO-SPEECH CONTENT

(71) Applicant: I AM PLUS Electronics Inc., Los Angeles, CA (US)

(72) Inventors: So Young SHIN, Los Angeles, CA (US); Yuan-Yi FAN, Los Angeles, CA (US); Vidyut SAMANTA, Los Angeles, CA (US)

(73) Assignee: I AM PLUS Electronics Inc., Los Angeles, CA (US)

(21) Appl. No.: 16/033,776

(22) Filed: Jul. 12, 2018

Related U.S. Application Data
(60) Provisional application No. 62/531,848, filed on Jul. 12, 2017.

(51) Int. Cl. G10L 13/033; G10L 25/24; G10L 25/90; G10L 13/047

(52) U.S. Cl. CPC G10L 13/033; G10L 13/047; G10L 25/90; G10L 25/24

(57) ABSTRACT

Methods and systems for audio content production are provided whereby expressive speech is generated via acoustic elements extracted from human input. One of the inputs to the system is a human designating an intonation to be applied onto text-to-speech (TTS) generated synthetic speech. The human intonation includes the pitch contour and other acoustic features extracted from the speech. The system is designed to be used for, and is capable of speech generation, speech analysis, speech transformation, and speech re-synthesis at the acoustic level.

### CROSS REFERENCES TO RELATED APPLICATIONS

This application claims the benefit of U.S. Provisional Patent Application No. 62/531,848, entitled “A Method for Providing Expressive Control of Text-to-Speech,” filed on Jul. 12, 2017, which is hereby expressly incorporated herein by reference in its entirety.

### FIELD OF TECHNOLOGY

The present disclosure relates generally to audio content production and, more particularly, to improved control over text-to-speech processing.

### BACKGROUND

Voice assistant technology has expanded the design space for voice-activated consumer products and audio-centric user experience. With the proliferation of hands-free voice-controlled consumer electronics has come an increase in the demand for audio content. To navigate this emerging design space, Speech Synthesis Markup Language (SSML) provides a standard to control output of synthetic speech systems based on parametric control of the prosody and style elements (e.g., pitch, rate, volume, contour, range, duration, voice, emphasis, break, etc.).

### SUMMARY

One embodiment of the present disclosure relates to a computer-implemented method for audio content production, the method comprising: obtaining input to be generated into speech; determining one or more acoustic features to be applied to the speech to be generated for the input; applying the one or more acoustic features to synthesized speech corresponding to the input; and generating audio data that represents the synthesized speech with the one or more acoustic features applied.

Another embodiment of the present disclosure relates to a system for generating audio content, the system including a data storage device that stores instructions for audio content processing, and a processor configured to execute the instructions to perform a method including: obtaining input to be generated into speech; determining one or more acoustic features to be applied to the speech to be generated for the input; applying the one or more acoustic features to synthesized speech corresponding to the input; and generating audio data that represents the synthesized speech with the one or more acoustic features applied.

Yet another embodiment of the present disclosure relates to a computer-readable storage device storing instructions that, when executed by a computer, cause the computer to perform a method for generating audio content, the method including: obtaining input to be generated into speech; determining one or more acoustic features to be applied to the speech to be generated for the input; applying the one or more acoustic features to synthesized speech corresponding to the input; and generating audio data that represents the synthesized speech with the one or more acoustic features applied.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

In the course of the detailed description to follow, reference will be made to the attached drawings. The drawings show different aspects of the present disclosure and, where appropriate, reference numerals illustrating like structures, components, materials and/or elements in different figures are labeled similarly. It is understood that various combinations of the structures, components, and/or elements, other than those specifically shown, are contemplated and are within the scope of the present disclosure.

Moreover, there are many embodiments of the present disclosure described and illustrated herein. The present disclosure is neither limited to any single aspect nor embodiment thereof, nor to any combinations and/or permutations of such aspects and/or embodiments. Moreover, each of the aspects of the present disclosure, and/or embodiments thereof, may be employed alone or in combination with one or more of the other aspects of the present disclosure and/or embodiments thereof. For the sake of brevity, certain permutations and combinations are not discussed and/or illustrated separately herein.

FIG. 1 is a block diagram conceptually illustrating a device for text-to-speech processing, according to one or more embodiments.

FIG. 2 is a data flow diagram showing example data flows of a text-to-speech module, according to one or more embodiments.

FIG. 3 is a flowchart illustrating an example process for identifying and storing acoustic features of voice input, according to one or more embodiments.

FIG. 4 is a flowchart illustrating an example process for generating audio content, according to one or more embodiments.

FIG. 5 illustrates a high-level example of a computing device that may be used in accordance with the systems, methods, modules, and computer-readable media disclosed herein, according to one or more embodiments.

FIG. 6 illustrates a high-level example of a computing system that may be used in accordance with the systems, methods, modules, and computer-readable media disclosed herein, according to one or more embodiments.

Again, there are many embodiments described and illustrated herein. The present disclosure is neither limited to any single aspect nor embodiment thereof, nor to any combinations and/or permutations of such aspects and/or embodiments. Each of the aspects of the present disclosure, and/or embodiments thereof, may be employed alone or in combination with one or more of the other aspects of the present disclosure and/or embodiments thereof. For the sake of brevity, many of those combinations and permutations are not discussed separately herein.

### DETAILED DESCRIPTION OF EMBODIMENTS

One skilled in the art will recognize that various implementations and embodiments of the present disclosure may be practiced in accordance with the specification. All of these implementations and embodiments are intended to be included within the scope of the present disclosure.

As used herein, the terms “comprises,” “comprising,” “have,” “having,” “include,” “including,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. The term “exemplary” is used in the sense of “example,” rather than “ideal.” Additionally, the term “or” is intended to mean an inclusive “or” rather than an exclusive “or.” That is, unless specified otherwise, or clear from the context, the phrase “X employs A or B” is intended to mean any of the natural inclusive permutations. For example, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

For the sake of brevity, conventional techniques related to systems and servers used to conduct methods and other functional aspects of the systems and servers (and the individual operating components of the systems) may not be described in detail herein. Furthermore, the connecting lines shown in the various figures contained herein are intended to represent exemplary functional relationships and/or physical couplings between the various elements. It should be noted that many alternative and/or additional functional relationships or physical connections may be present in an embodiment of the subject matter.

Reference will now be made in detail to the exemplary embodiments of the disclosure, examples of which are illustrated in the accompanying drawings. Wherever possible, the same reference numbers will be used throughout the drawings to refer to the same or like parts.

Embodiments of the present disclosure relate to a tool and workflow for generation of expressive speech via acoustic elements extracted from human input. In at least one embodiment, a system for audio content production is designed to utilize acoustic features to increase the expressiveness of generated audio. One of the inputs to the system is a human designating an intonation to be applied onto text-to-speech (TTS) generated synthetic speech, in some embodiments. The human intonation includes the pitch contour and can also include other acoustic features extracted from the speech. The pitch contour is an example of a “contour”. However, in the context of the present disclosure, anything that uses an acoustic feature as a guide may also be considered a “contour.” In lieu of TTS, genuine speech can be used as the base input to the system, in some embodiments. The system is designed to be used for, and is capable of speech generation, speech analysis, speech transformation, and speech re-synthesis at the acoustic level.

Some embodiments described herein are designed to shape the tone of text-to-speech (TTS) such that synthesized speech is more expressive (users can target a specific expression). For example, in an embodiment, a TTS system is configured to enable a user to apply intonation from their own voice to generated TTS. In an embodiment, the user is enabled to listen to both the original TTS and the pitch-contoured TTS to compare the two versions and make further modifications as desired.

In some embodiments, an audio content production system includes a voice user interface (e.g., a microphone), for transformation and modification of text-to-speech signals. As compared to a conventional parametric (e.g., prosody and style elements in SSML) approach on a graphical user interface (e.g., display), the audio content production system and workflow of the present disclosure makes expressive control of text-to-speech more intuitive and efficient.

In a TTS system, a device converts input text into an acoustic waveform that is recognizable as speech corresponding to the input text, in an embodiment. The TTS system may provide spoken output to a user in a number of different contexts or applications, enabling the user to obtain information from a device without necessarily having to rely on conventional visual output devices, such as a display screen or monitor, in an embodiment. In some embodiments, a TTS process is referred to as speech synthesis or speech generation.

In at least some embodiments and examples described herein, the term “prosody” is broadly used to cover a wide range of speech characteristics. For example, prosody includes variations in volume, pitch, speech rate, and pauses. In one or more embodiments, prosody may also include qualities related to inflection and intonation. As will be described in greater detail below, acoustic feature (e.g., pitch, rate, volume, contour, range, duration, voice, emphasis, break, etc.) modification is an important processing component of expressive TTS synthesis and voice transformation. The acoustic feature modification task may generally appear either in the context of TTS synthesis or in the context of natural speech processing.

It is valuable to craft the audio-centric user experience of a personal voice assistant using intentful sound design that expresses the emotion of what is being communicated. Furthermore, as news and information is disseminated with increasing speed, content is often needed on short timelines. Accordingly, in one or more embodiments described herein, methods and systems are provided for an efficient and intelligent workflow for audio (e.g., TTS) production of timely content. As will be described in greater detail herein, the present disclosure provides a novel integration of natural user interfaces (e.g., voice input) and acoustic feature extraction to enable an efficient and intelligent workflow for more expressive audio production of timely content, in some embodiments.

To improve user experience on voice-enabled products, more techniques need to be adapted from audio and radio production. One existing approach examines audio/metadata workflow, roles and motivations of the producers, and environmental factors at BBC via observations and interviews, to aid understanding of how audio analysis techniques could help in the radio production process. Another existing approach presents a semi-automated tool that facilitates speech and music processing for high quality production, and further explores integrating music retargeting tools that facilitates combining music with speech. While these existing techniques attempt to integrate a new process (e.g., audio analysis) into the workflow to assist audio content production, neither approach adequately addresses the process of producing speech spoken in intended tones. Instead, existing approaches such as these are limited by the unnaturalness in prosody.

In view of the lack of expressiveness and unnaturalness in prosody associated with conventional voice assistant technology, some embodiments of the present disclosure provide a new audio production workflow for more efficient and emotional audio content using TTS. Accordingly, in some embodiments, a system is provided that allows a user to produce TTS-based content in any emotional tone using voice input. Conceptually, the voice-guided (via extracted acoustic features) speech re-synthesis process is a module of an end-to-end TTS system, in some embodiments. In the case of pitch contour (an acoustic feature) modification, an output can be approximated by interpolating a reference contour to a target contour, in some embodiments.

The methods and systems of the present disclosure enable a user to create TTS that is more expressive as part of a content production workflow. In some embodiments, a voice user interface (VUI) is used to control pitch of synthesized speech. For example, in some embodiments, the voice user interface is configured to analyze a speech signal that characterizes a user's articulatory style via pitch contour, and re-synthesizes speech that approximates the intended style of the user. The voice user interface is capable of capturing a user's voice input via an audio input device (e.g., microphone) and generating a visual representation of the characteristics of an articulatory style based on the captured voice input, in an embodiment. The voice user interface may be configured to playback (e.g., via an audio output device such as, for example, a speaker) the captured voice input of the user, text-to-speech output, and resynthesized speech, in some embodiments. The voice user interface may be integrated into an audio content production workflow such that a user is enabled to use voice as input to produce speech content in various emotional tones.

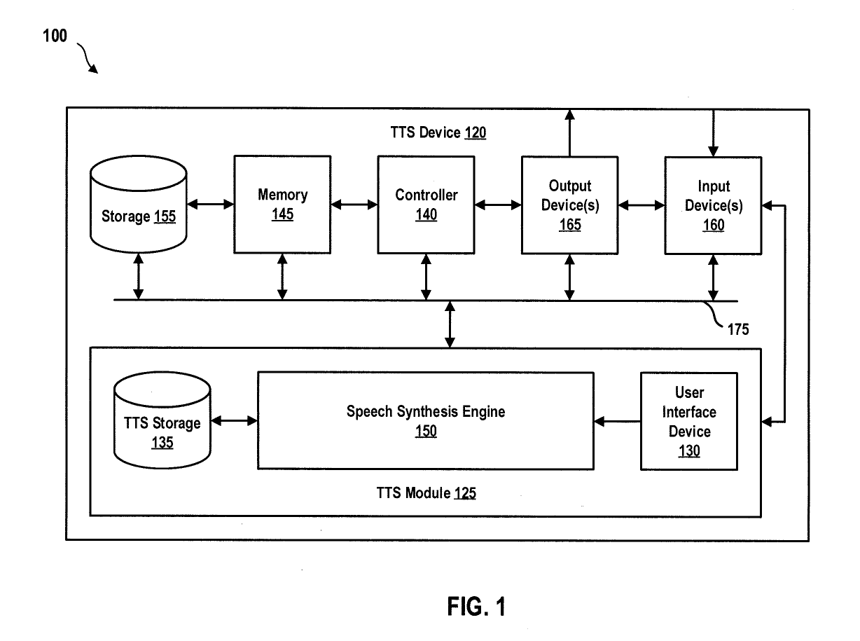

FIG. 1 illustrates an example TTS system 100 according to some embodiments. In an embodiment, the TTS system 100 includes a TTS device 120 configured to perform speech processing including, for example, speech synthesis. For example, in an embodiment, the TTS device 120 is configured to obtain input (e.g., text input, voice input, or a combination thereof) to be generated into speech, determine one or more acoustic features to be applied to the speech to be generated for the input, apply the one or more acoustic features to synthesized speech corresponding to the input, and generate audio data that represents the synthesized speech with the one or more acoustic features applied. The acoustic features can include, for example, FO (e.g., pitch, fundamental frequency), harmonics, MFCC, timing of voiced/unvoiced sections, duration, etc., in an embodiment. Such low-level acoustic features can be used as a front-end module for a data-driven or end-to-end text-to-speech system, in an embodiment. In some embodiments, the TTS device 120 is configured to obtain voice input from a user and identify (e.g., determine, derive, extract, etc.) at least one acoustic feature of the voice input. The TTS device 120 may store the voice input and the at least one acoustic feature of the voice input in a database (e.g., TTS storage 135), in an embodiment. The TTS device 120 may also store user behaviors using the audio content production workflow described in accordance with some embodiments. For example, the TTS device 120 may store design iterations (e.g., time to complete task, number of design iterations quantified by preview button click events, etc.) and/or design decisions (e.g., final production files), in an embodiment. The TTS device 120 may use digital signal processing and machine learning to generate a new acoustic feature based on one or more of (i) the at least one acoustic feature, (ii) the voice input, and (iii) the at least one user behavior stored in the database, in some embodiments. For example, a library of acoustic features may be built, and such library can be used to derive additional acoustic features and/or identify patterns in the acoustic features, in an embodiment. In some embodiments, the TTS device 120 is configured to re-synthesize synthesized speech to include at least one acoustic feature derived from the one or more acoustic features.

In some embodiments, computer-readable and computer-executable instructions may reside on the TTS device 120. For example, in an embodiment, computer-readable and computer-executable instructions are stored in a memory 145 of the TTS device 120. It should be noted that while numerous components are shown as being part of the TTS device 120, various other components or groups of components (not shown) may also be included, in some embodiments. Also, one or more of the illustrated components may not be present in every implementation of the TTS device 120 capable of employing aspects of the present disclosure. It should also be understood that one or more illustrated components of the TTS device 120 may, in some embodiments, exist in multiples in the TTS device 120. For example, the TTS device 120 may include multiple output devices 165, input devices 160, and/or multiple controllers (e.g., processors) 140.

In some embodiments, the TTS system 100 may include multiple TTS devices 120, which may operate together or separately in the TTS system 100. In such embodiments, one or more of the TTS devices 120 may include similar components or different components from one another. For example, one TTS device 120 may include components for performing certain operations related to speech synthesis while another TTS device 120 may include different components for performing different operations related to speech synthesis or other functions. The multiple TTS devices 120 may include overlapping components. The TTS device 120 as illustrated in FIG. 1 is exemplary, and may be a stand-alone device or may be included, in whole or in part, as a component of a larger device or system.

The methods and systems described herein may be applied within a number of different devices and/or computer systems, including, for example, server-client computing systems, general-purpose computing systems, mainframe computing systems, telephone computing systems, cellular phones, personal digital assistants (PDAs), laptop or tablet computers, and various other mobile devices, in some embodiments. In at least one embodiment, the TTS device 120 is a component of another device or system that may provide speech recognition functionality such as a “smart” appliance, voice-activated kiosk, and the like.

In some embodiments, the TTS device 120 includes data storage 155, a memory 145, a controller 140, one or more output devices 165, one or more input devices 160, and a TTS module 125. For example, in an embodiment, the TTS module 125 includes TTS storage, a speech synthesis engine 150, and a user interface device 130. The TTS device 120 may also include an address/data bus 175 for communication or conveying data among components of the TTS device 120. It should be noted that each of the components included within the TTS device 120 may also be directly or indirectly connected to one or more other components in addition to or instead of being connected to other components across the bus 175. While certain components in the TTS device 120 are shown as being directly connected, such connections are merely illustrative and other components may be directly connected to each other (e.g., the TTS module 125 may be directly connected to the controller/processor 140).

The TTS device 120 may include a controller/processor 140 that acts as a central processing unit (CPU) for processing data and computer-readable instructions, in an embodiment. The TTS device 120 may also include a memory 145 for storing instructions and data, in an embodiment. For example, the memory 145 may include volatile random access memory (RAM), non-volatile read only memory (ROM), and/or other types of memory. The data storage component 155 may be configured to store instructions and/or data, and may include one or more storage types such as magnetic storage, optical storage, solid-state storage, etc., in some embodiments.

The TTS device 120 may also be connected to removable or external memory and/or storage (e.g., a memory key drive, removable memory card, networked storage, etc.) through the one or more output devices 165, the one or more input device 160, or some combination thereof. Computer instructions for processing by the controller/processor 140 for operating the TTS device 120 and its various components may be executed by the controller/processor 140 and stored in the data storage 155, memory 145, an external device connected to the TTS device 120, or in memory/storage 135 included in the TTS module 125. In an embodiment, some or all of the executable instructions may be embedded in hardware or firmware in addition to or instead of software. The teachings of the present disclosure may be implemented in various combinations of software, firmware, and/or hardware, for example.

A variety of input/output device(s) may be included in the TTS device 120, in some embodiments. Examples of the one or more input devices 160 include a microphone, keyboard, mouse, stylus or other input device, or a touch input device. Examples of the one or more output devices 165 include audio speakers, headphones, printer, visual display, tactile display, or other suitable output devices. In some embodiments, the output devices 165 and/or input devices 160 may also include an interface for an external peripheral device connection such as universal serial bus (USB) or other connection protocol. The output devices 165 and/or input devices 160 may also include one or more network connections such as, for example, an Ethernet port, modem, etc., in some embodiments. The output devices 165 and/or input devices 160 may also include a wireless communication device, such as radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, etc. The TTS device 120 may utilize the one or more output devices 165 and/or the one or more input devices 160 to connect to a network, such as the Internet or private network, which may include a distributed computing environment.

In some embodiments, the TTS device 120 includes a TTS module 125 configured to process textual data into audio waveforms including speech. The TTS module 125 may be connected to the bus 175, controller 140, output devices 165, input devices 160, and/or various other component of the TTS device 120. The textual data that may be processed by the TTS module 125 may originate from an internal component of the TTS device 120 or may be received by the TTS device 120 from an input device such as a keyboard. In some embodiments, the TTS device 120 may be configured to receive textual data over a communication network from, for example, another network-connected device or system. The text that may be received by the TTS device 120 for processing or conversion into speech by the TTS module 125 may include text, numbers, and/or punctuation, and may be in the form of full sentences or fragments thereof, in some embodiments. For example, the input text received at the TTS device 120 may include indications of how the text input is to be pronounced when output as audible speech. Textual data may be processed in real time or may be saved and processed at a later time.

In some embodiments, the TTS module 125 includes a speech synthesis engine 150, TTS storage 135, and a user interface device 130. The user interface device 130 may be configured to transform input text data into a symbolic linguistic representation for processing by the speech synthesis engine 150, in an embodiment. In some embodiments, the speech synthesis engine 150 may utilize various acoustic feature models and voice input information stored in the TTS storage 135 to convert input text into speech and to tune the synthesized speech according to one or more acoustic features associated with a particular user (e.g., one or more acoustic features that have been extracted or identified from voice input of the user). The user interface device 130 and/or the speech synthesis engine 150 may include their own controllers/processors and/or memory (not shown), in some embodiments. The instructions for controlling or operating the speech synthesis engine 150 and/or the user interface device 130 may be stored in the data storage 155 of the TTS device 120 and may be processed by the controller 140 of the TTS device 120.

In some embodiments, text input to the TTS module 125 may be processed by the user interface device 130. For example, the user interface device 130 may include modules for performing text normalization, linguistic analysis, and linguistic prosody generation. During text normalization, for example, the user interface device 130 may be configured to process the text input to generate standard text, for example, by converting such things as numbers, symbols, abbreviations, etc., into the equivalent of written out words.

In some embodiments, fundamental frequency of a recorded voice file can be extracted using a library for FFT (Fast-Fourier Transform).

The speech synthesis engine 150 may be configured to perform speech synthesis using any appropriate method known to those of ordinary skill in the art. For example, the speech synthesis engine 150 may be configured to perform one or more operations by modeling the vocal tract, using a unit selection approach, or using end-to-end sample-based synthesis, in some embodiments. In an embodiment where the speech synthesis engine 150 models the vocal tract, a simulation of the interactions between different body parts in the vocal region for a given utterance is enacted. In an embodiment where the speech synthesis engine 150 utilizes unit selection, a corpus of speech samples covering all the possible sounds in a language is uttered by a human. The corpus is then used by the speech synthesis engine 150 to synthesize speech based on phonetic representations of written speech, choosing these “units” for their appropriateness in the synthesis (“hello” may be synthesized by a series of units representing “h” “elle” and “oh” for instance). Improvements on unit selection such as, for example, Hidden Markov Models (HMM) may also be used by the speech synthesis engine 150, in some embodiments. In embodiments where end-to-end sample-based synthesis is implemented, the speech synthesis engine 150 relies on generative and linguistic models in order to create waveforms rather than using sampling corpora. It should be noted that numerous suitable sample-based synthesis techniques, some of which may still be in development, may be used by the speech synthesis engine 150.

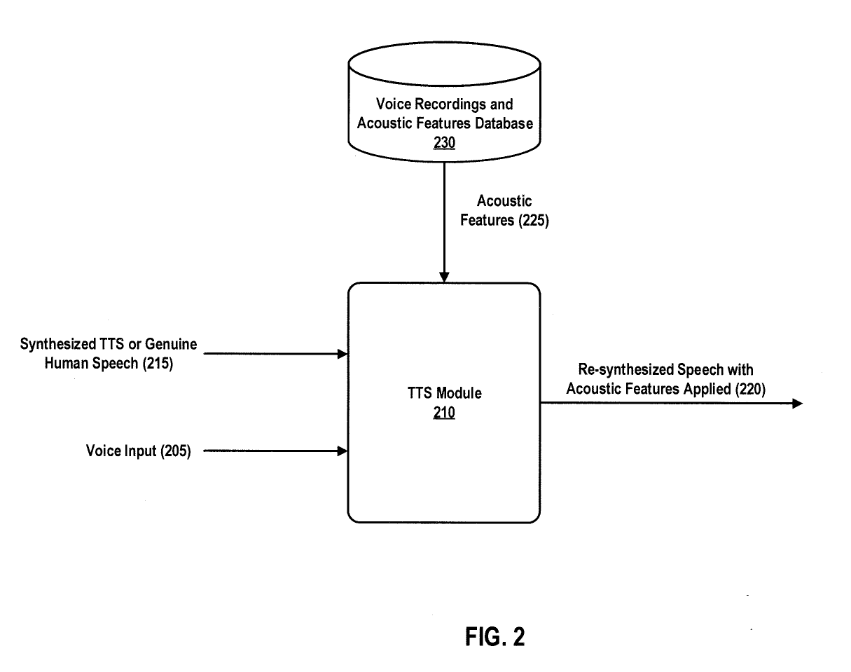

FIG. 2 is a data flow diagram showing example data flows of a TTS module, according to some embodiments. The TTS module 210 may be similar to TTS module 125, in an embodiment. In an embodiment, the TTS module 210 may be configured to receive (e.g., retrieve, extract, obtain, etc.) synthesized TTS or genuine human speech (215). For example, the synthesized TTS or genuine human speech (215) may be received from one or more external sources or systems, in an embodiment. The TTS module 210 may also receive voice input (205). For example, the voice input (205) may be received from a user associated with a TTS device (e.g., TTS device 120). In at least some embodiments, the TTS module 210 may select (e.g., receive, obtain, etc.) one or more acoustic features (225) (e.g., acoustic feature references, acoustic feature models, etc.) from a database (230) of voice recordings and acoustic features. The selected acoustic features (225) may be specific to a particular user who generated the voice recordings stored in the database (230). In some embodiments, the TTS module 210 may be configured to generate (e.g., determine, identify, derive, etc.) the acoustic features (225) based on the received voice input (205), rather than select the acoustic features (225) from the database (230). The generated acoustic features (225) may correspond to acoustic features detected in the voice input by the TTS module 210, in an embodiment. The TTS module 210 may be configured to apply the acoustic features or acoustic feature models (225) to the synthesized TTS or human speech (215) received at the TTS module 210. For example, in an embodiment, the TTS module is configured to generate re-synthesized speech (220) with the acoustic features (225) applied. For example, the re-synthesized speech with the acoustic features applied (220) may include the synthesized TTS or human speech (215) with the acoustic features or changes in acoustic features detected in the voice input (205) incorporated therein, in an embodiment.

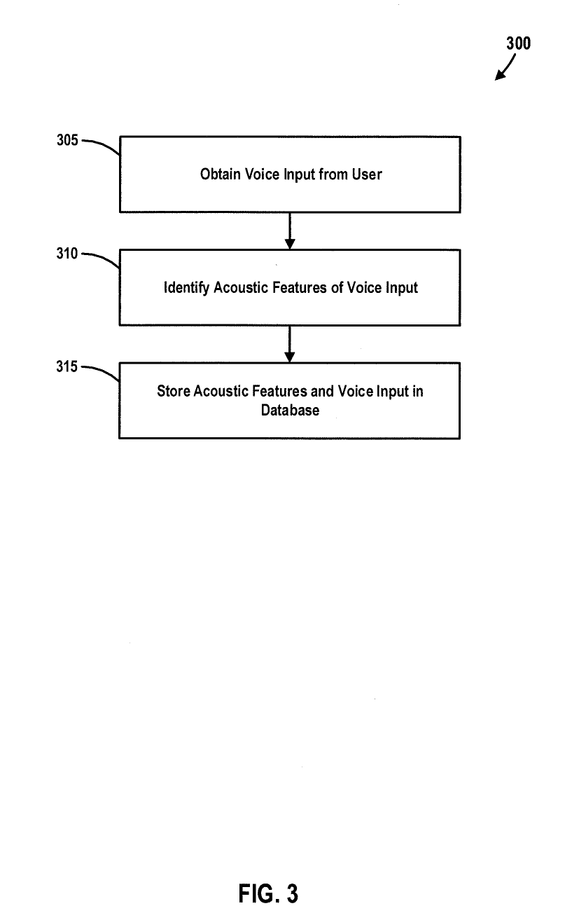

FIG. 3 is a flowchart illustrating an example process for identifying and storing acoustic features of voice input, according to one or more embodiments. In some embodiments, the method 300 may be performed by a TTS device (e.g., TTS device 120). In an embodiment, the method 300 may be performed by a TTS module (e.g., TTS module 125). In some embodiments, one or more of the operations comprising method 300 may be performed by a user interface device (e.g., user interface device 130) and one or more of the operations may be performed by a speech synthesis engine (e.g., speech synthesis engine 150).

At block 305, voice input (e.g., a voice recording) may be obtained from a user. At block 310, acoustic features may be identified (e.g., extracted, determined, derived, etc.) from the voice input obtained at block 305. In some embodiments, the identification of the acoustic features at block 310 is performed using one or more of a variety of techniques including, for example, FO extraction, harmonics extraction, identification of the Mel-frequency cepstral coefficients (MFCC), timing of voiced and unvoiced sections. FO (fundamental frequency) and harmonics of a voice recording can be estimated using either a time-domain or frequency-domain method, such as Fast-Fourier Transform (FFT), in an embodiment. MFCC of a voice recording can be estimated based on a linear cosine transform of a log power spectrum on a nonlinear mel scale of frequency, in an embodiment. Timing of voiced and unvoiced sections can be estimated using a band-pass-filter mechanism with a threshold that detects voiced versus unvoiced band, in an embodiment. At block 315, the identified acoustic features and the voice input may be stored (e.g., in database 230). In some implementations, a large library of acoustic features may be built or collected. Therefore, in some embodiments, machine learning is used to generate new acoustic features based on the existing library, and/or is used to identify patterns in acoustic features belonging to the existing library.

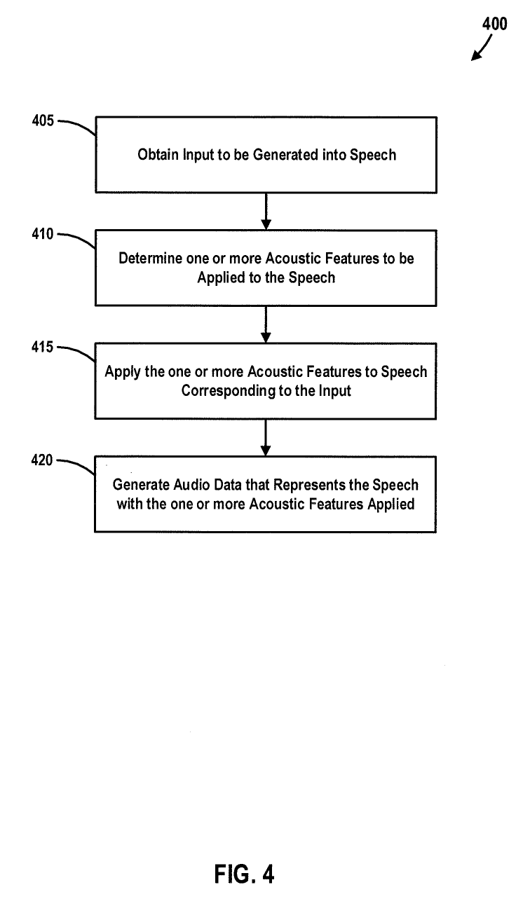

FIG. 4 is a flowchart illustrating an example method for generating audio content, according to some embodiments. In some embodiments, the method 400 may be performed by a TTS device (e.g., TTS device 120). In an embodiment, the method 400 may be performed by a TTS module (e.g., TTS module 125). In some embodiments, one or more of the operations comprising method 400 may be performed by a user interface device (e.g., user interface device 130) and one or more of the operations may be performed by a speech synthesis engine (e.g., speech synthesis engine 150).

At block 405, input to be generated (e.g., synthesized) into speech is obtained. For example, the input obtained at block 405 is text input, in an embodiment. In another embodiment, the input obtained at block 405 is voice input. In yet another embodiment, the input obtained at block 405 is a combination of text and voice input. At block 410, one or more acoustic features to be applied to the speech are determined. For example, a voice input is obtained from a user and acoustic features are identified from the voice input, in some embodiments. The identified acoustic features and the voice input are stored in a database (e.g., database 230), in some embodiments. At block 415, the one or more acoustic features determined at block 410 are applied to speech (e.g., synthesized speech, genuine human speech, etc.) corresponding to the input obtained at block 305. At block 420, audio data is generated, where the audio data represents the speech with the one or more acoustic features applied.

In one or more embodiments of the present disclosure, the audio content production workflow may utilize a combination of the voice input and the parametric input. An example of such embodiment enables fast design iterations using voice input and finer control using parametric tuning. For example, the audio content production system and workflow of the present disclosure allows a user the option of manually adjusting or moving control points in a graph to manipulate the shape of a contour, in some embodiments. In an embodiment in which the audio content production workflow utilizes a combination of the voice input and the parametric input, the system allows a user to adjust the shape of a contour using similar control points.

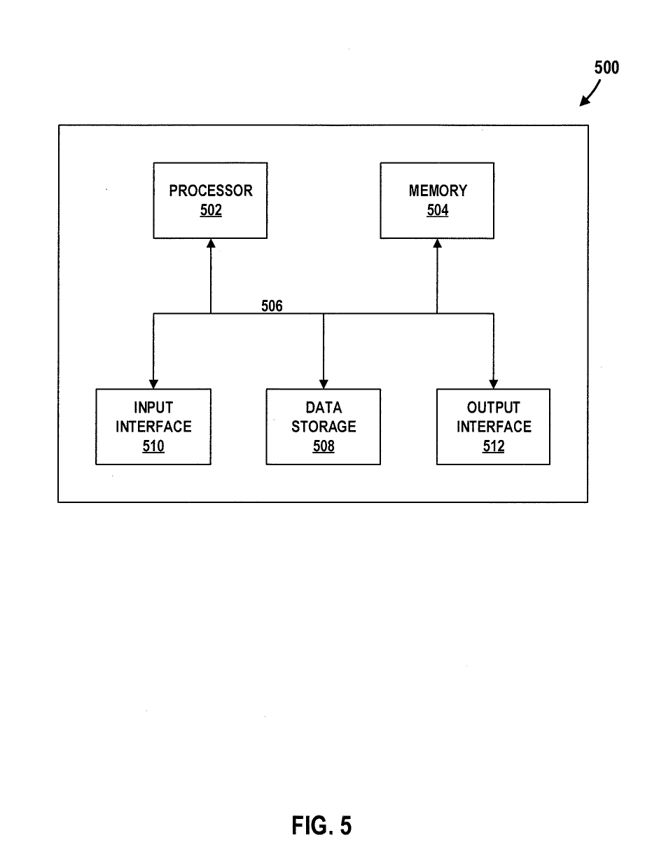

FIG. 5 depicts a high-level illustration of an exemplary computing device 400 that may be used in accordance with the systems, methods, modules, and computer-readable media disclosed herein, according to embodiments of the present disclosure. For example, the computing device 500 may be used in a system that processes data, such as audio data, using a deep neural network, according to some embodiments of the present disclosure. The computing device 500 may include at least one processor 502 that executes instructions that are stored in a memory 504. The instructions may be, for example, instructions for implementing functionality described as being carried out by one or more components discussed above or instructions for implementing one or more of the methods described above. The processor 502 may access the memory 504 by way of a system bus 506. In addition to storing executable instructions, the memory 504 may also store data, audio, one or more deep neural networks, and so forth.

The computing device 500 may additionally include a data storage, also referred to as a database, 508 that is accessible by the processor 502 by way of the system bus 506. The data storage 508 may include executable instructions, data, examples, features, etc. The computing device 500 may also include an input interface 510 that allows external devices to communicate with the computing device 500. For instance, the input interface 510 may be used to receive instructions from an external computer device, from a user, etc. The computing device 500 also may include an output interface 512 that interfaces the computing device 500 with one or more external devices. For example, the computing device 500 may display text, images, etc. by way of the output interface 512.

It is contemplated that the external devices that communicate with the computing device 500 via the input interface 510 and the output interface 512 may be included in an environment that provides substantially any type of user interface with which a user can interact. Examples of user interface types include graphical user interfaces, natural user interfaces, and so forth. For example, a graphical user interface may accept input from a user employing input device(s) such as a keyboard, mouse, remote control, or the like and may provide output on an output device such as a display. Further, a natural user interface for TTS generation may enable a user to interact with the computing device 500 in a manner free from constraints imposed by input device such as keyboards, mice, remote controls, and the like. Rather, a natural user interface may rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 500 may be a distributed system. Thus, for example, several devices may be in communication by way of a network connection and may collectively perform tasks described as being performed by the computing device 400.

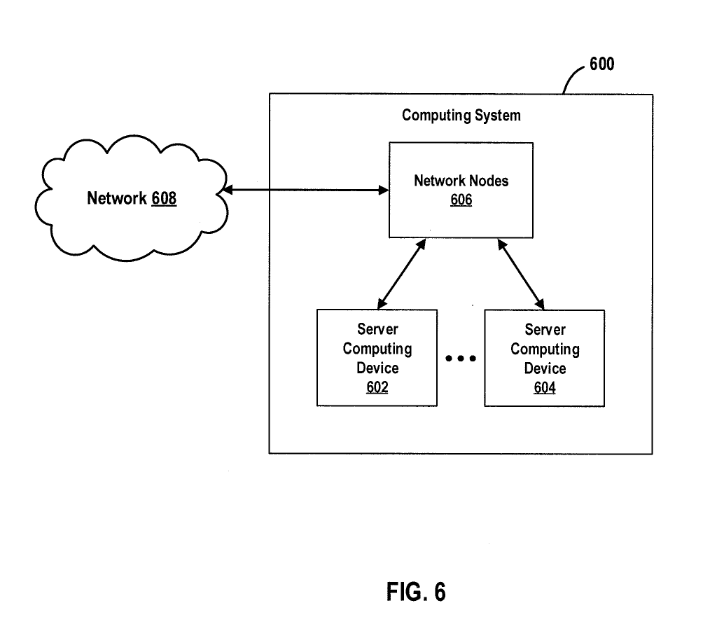

FIG. 6 illustrates a high-level example of an exemplary computing system 600 that may be used in accordance with the systems, methods, modules, and computer-readable media disclosed herein, according to embodiments of the present disclosure. For example, the computing system 600 may be or may include the computing device 500 described above and illustrated in FIG. 5, in an embodiment. Additionally, and/or alternatively, the computing device 500 may be or may include the computing system 600, in an embodiment.

The computing system 600 may include a plurality of server computing devices, such as a server computing device 602 and a server computing device 504 (collectively referred to as server computing devices 602-604). The server computing device 602 may include at least one processor and a memory; the at least one processor executes instructions that are stored in the memory. The instructions may be, for example, instructions for implementing functionality described as being carried out by one or more components discussed above or instructions for implementing one or more of the methods described above. Similar to the server computing device 602, at least a subset of the server computing devices 602-604 other than the server computing device 602 each may respectively include at least one processor and a memory. Moreover, at least a subset of the server computing devices 602-604 may include respective data storage devices or databases.

Processor(s) of one or more of the server computing devices 602-604 may be or may include the processor, such as processor 502. Further, a memory (or memories) of one or more of the server computing devices 602-604 can be or include the memory, such as memory 504. Moreover, a data storage (or data stores) of one or more of the server computing devices 602-604 may be or may include the data storage, such as data storage 508.

The computing system 500 may further include various network nodes 606 that transport data between the server computing devices 602-604. Moreover, the network nodes 606 may transport data from the server computing devices 602-604 to external nodes (e.g., external to the computing system 600) by way of a network 608. The network nodes 602 may also transport data to the server computing devices 602-604 from the external nodes by way of the network 608. The network 608, for example, may be the Internet, a cellular network, or the like. The network nodes 606 may include switches, routers, load balancers, and so forth.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Various functions described herein may be implemented in hardware, software, or any combination thereof. If implemented in software, the functions may be stored on and/or transmitted over as one or more instructions or code on a computer-readable medium. Computer-readable media may include computer-readable storage media. A computer-readable storage media may be any available storage media that may be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, may include compact disc (“CD”), laser disc, optical disc, digital versatile disc (“DVD”), floppy disk, and Blu-ray disc (“BD”), where disks usually reproduce data magnetically and discs usually reproduce data optically with lasers. Further, a propagated signal is not included within the scope of computer-readable storage media. Computer-readable media may also include communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio and microwave are included in the definition of communication medium. Combinations of the above may also be included within the scope of computer-readable media.

Alternatively, and/or additionally, the functionality described herein may be performed, at least in part, by one or more hardware logic components. For example, and without limitation, illustrative types of hardware logic components that may be used include Field-Programmable Gate Arrays (“FPGAs”), Application-Specific Integrated Circuits (“ASICs”), Application-Specific Standard Products (“ASSPs”), System-on-Chips (“SOCs”), Complex Programmable Logic Devices (“CPLDs”), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

What is claimed is:

1. A computer-implemented method for generating audio content, the method comprising:
obtaining input to be generated into speech;
determining one or more acoustic features to be applied to the speech to be generated for the input;
applying the one or more acoustic features to synthesized speech corresponding to the input; and
generating audio data that represents the synthesized speech with the one or more acoustic features applied.

2. The method of claim 1, wherein determining one or more acoustic features to be applied to speech corresponding to the input includes:
obtaining voice input from a user; and
identifying at least one acoustic feature of the voice input.

3. The method of claim 2, further comprising:
storing the voice input and the at least one acoustic feature of the voice input in a database; and
storing at least one user behavior for the user in the database.

4. The method of claim 3, further comprising:
generating a new acoustic feature based on one or more of (i) the at least one acoustic feature, (ii) the voice input, and (iii) the at least one user behavior stored in the database, wherein the new acoustic feature is generated using digital signal processing and machine learning.

5. The method of claim 1, further comprising causing the audio data that represents the synthesized speech with the one or more acoustic features applied to be output.

6. The method of claim 1, wherein the one or more acoustic features includes one or more of pitch, fundamental frequency, harmonics, Mel-frequency cepstral coefficients (MFCC), and timing of voiced and unvoiced sections.

7. The method of claim 1, wherein applying the one or more acoustic features to synthesized speech corresponding to the input includes re-synthesizing the synthesized speech to include at least one acoustic feature derived from the one or more acoustic features.

8. A system for generating audio content, the system including:
a data storage device that stores instructions for audio content processing; and
a processor configured to execute the instructions to perform a method including:
obtaining input to be generated into speech;
determining one or more acoustic features to be applied to the speech to be generated for the input;
applying the one or more acoustic features to synthesized speech corresponding to the input; and
generating audio data that represents the synthesized speech with the one or more acoustic features applied.

9. The system of claim 8, wherein the processor is further configured to execute the instructions to perform the method including:
obtaining voice input from a user; and
identifying at least one acoustic feature of the voice input.

10. The system of claim 9, wherein the processor is further configured to execute the instructions to perform the method including:
storing the voice input and the at least one acoustic feature of the voice input in a database; and
storing at least one user behavior for the user in the database.

11. The system of claim 10, wherein the processor is further configured to execute the instructions to perform the method including:
generating a new acoustic feature based on one or more of (i) the at least one acoustic feature, (ii) the voice input, and (iii) the at least one user behavior stored in the database, wherein the new acoustic feature is generated using digital signal processing and machine learning.

12. The system of claim 8, wherein the processor is further configured to execute the instructions to perform the method including:
causing the audio data that represents the synthesized speech with the one or more acoustic features applied to be output.

13. The system of claim 8, wherein the one or more acoustic features includes one or more of pitch, fundamental frequency, harmonics, Mel-frequency cepstral coefficients (MFCC), and timing of voiced and unvoiced sections.

14. The system of claim 8, wherein the processor is further configured to execute the instructions to perform the method including:
re-synthesizing the synthesized speech to include at least one acoustic feature derived from the one or more acoustic features.

15. A computer-readable storage device storing instructions that, when executed by a computer, cause the computer to perform a method for generating audio content, the method including:
obtaining input to be generated into speech;
determining one or more acoustic features to be applied to the speech to be generated for the input;
applying the one or more acoustic features to synthesized speech corresponding to the input; and
generating audio data that represents the synthesized speech with the one or more acoustic features applied.

16. The computer-readable storage device according to claim 15, wherein the method further comprises:
obtaining voice input from a user; and
identifying at least one acoustic feature of the voice input.

17. The computer-readable storage device according to claim 16, wherein the method further comprises:
storing the voice input and the at least one acoustic feature of the voice input in a database; and
storing at least one user behavior for the user in the database.

18. The computer-readable storage device according to claim 17, wherein the method further comprises:
generating a new acoustic feature based on one or more of (i) the at least one acoustic feature, (ii) the voice input, and (iii) the at least one user behavior stored in the database, wherein the new acoustic feature is generated using digital signal processing and machine learning.

19. The computer-readable storage device according to claim 15, wherein the one or more acoustic features includes one or more of pitch, fundamental frequency, harmonics, Mel-frequency cepstral coefficients (MFCC), and timing of voiced and unvoiced sections.

20. The computer-readable storage device according to claim 15, wherein the method further comprises:
re-synthesizing the synthesized speech to include at least one acoustic feature derived from the one or more acoustic features.
